(19) United States
(12) Patent Application Publication
(10) Pub. No.: US 2024/0192383 A1
(43) Pub. Date: Jun. 13, 2024

(54) PIN REDUCTION DESIGN OF GPS SYNCHRONIZATION SIGNALS FOR AUTONOMOUS VEHICLES

(71) Applicant: Apollo Autonomous Driving USA LLC, Sunnyvale, CA (US)

(72) Inventor: Qiang WANG, Sunnyvale, CA (US)

(21) Appl. No.: 18/078,509

(22) Filed: Dec. 9, 2022

(51) Int. Cl. G01S 19/37; B60W 60/00; G04R 20/04

(52) U.S. Cl. CPC G01S 19/37; B60W 60/00; G04R 20/04; B60W 2556/50

(57) ABSTRACT

In one embodiment, a system receives a first synchronization signal from an electronics receiver, the electronics receiver receives one or more signals from one or more communication satellites of a navigation satellite system. The system receives a second synchronization signal from the electronics receiver. The system generates a data stream based on the first and second synchronization signals. the system transmits the data stream to one or more subsystems or sensor modules of an autonomous driving vehicle (ADV), wherein the data stream is used for localization and time synchronization for the one or more subsystems or sensor modules.

### TECHNICAL FIELD

Embodiments of the present disclosure relate generally to operating autonomous driving vehicles. More particularly, embodiments of the disclosure relate to pin reduction design of global positioning system (GPS) synchronization signals for autonomous driving vehicles (ADVs).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. The accuracy and efficiency of the motion planning and control depends heavily on the accuracy of a plurality of sensors. One such sensor is the global positioning system (GPS) sensor. The GPS sensor can provide time synchronization for the motion planning and control operations of the ADV.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating architecture of an autonomous driving system according to one embodiment.

FIGS. 5A-5B are block diagrams illustrating an example of a sensor unit according to one embodiment.

FIG. 6 is a block diagram illustrating an example of a GPS data stream generation module according to one embodiment.

FIG. 7 illustrates a time diagram of GPS data stream generation according to one embodiment.

FIG. 8 illustrates examples of GPS synchronization data streams according to one embodiment.

FIG. 9 is a flow diagram of a method to generate a GPS data stream according to one embodiment.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a system and method combines at least two GPS synchronization signals into one signal to reduce the number of connection wires required to provide the GPS synchronization signals to other subsystems and/or sensor modules of an autonomous driving vehicle (ADV).

Conventionally, global positioning system (GPS) can provide precise positioning information for a vehicle. Due to the precision of the GPS time clock, a GPS synchronization signal is usually used to synchronize different devices and sensors of an ADV.

The GPS synchronization signals can include a pulse-per-second (PPS) signal, as named, provides a precise pulse per second signal by way of the signal's sharp rising edge, with a precision in the orders of a few nanoseconds (ns) to microseconds (μs). The PPS signal requires a high speed bus (approximately 100 MHz). The GPS synchronization signals can further include a data signal that provides detailed timing information in the navigation marine electronics association (NMEA) format, such as the GPRMC or GPZDA formats. The data signal arrives approximately half a second before the PPS signal. Because the timing information does not require fast signaling, a universally asynchronous receiver-transmitter (UART) protocol is usually used to transfer these information to downstream subsystems and/or modules. The signaling to distribute the GPS synchronization information to subsequent subsystems/sensors requires multiple signal interconnects with varying timing requirements.

Conventionally, two signal interconnects are used to route these two GPS synchronization signals to each subsequent subsystems/sensors. Such routing can be cumbersome especially when the number of sub-system and/or sensor modules is numerous.

According to an embodiment, a system receives a first synchronization signal from an electronics receiver, the electronics receiver receives one or more signals from one or more communication satellites of a navigation satellite system (such as the GPS). The system receives a second synchronization signal from the electronics receiver. The system generates a data stream based on the first and second synchronization signals. the system transmits the data stream to one or more subsystems or sensor modules of an autonomous driving vehicle (ADV), wherein the data stream is used for localization and time synchronization for the one or more subsystems or sensor modules. The data stream is signaled by a single interconnect. Thus, only a single interconnect is required to route two GPS synchronization signals to a subsequent subsystem/sensor.

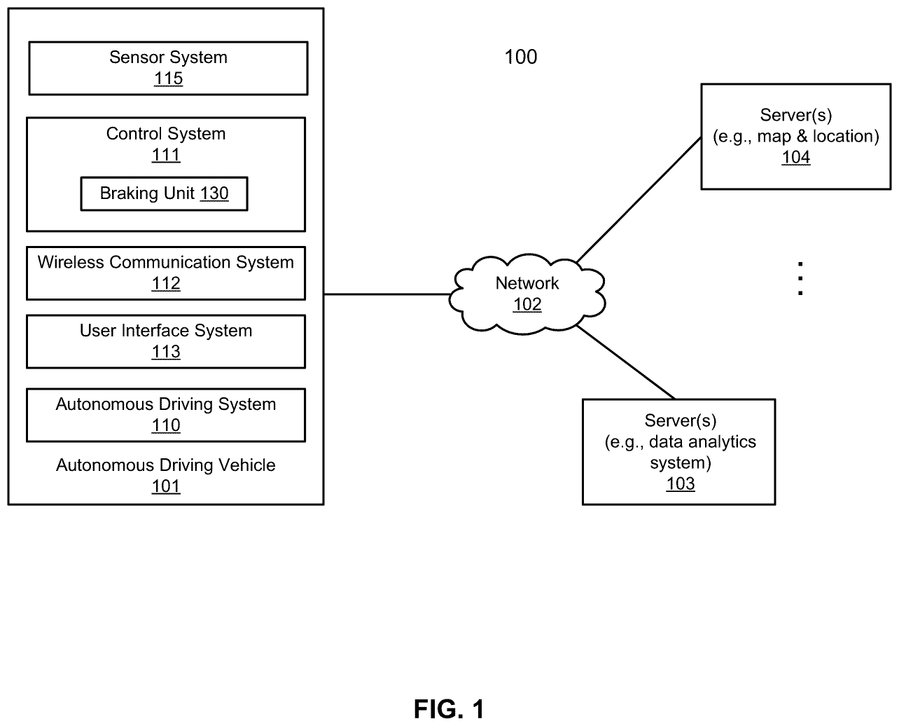

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

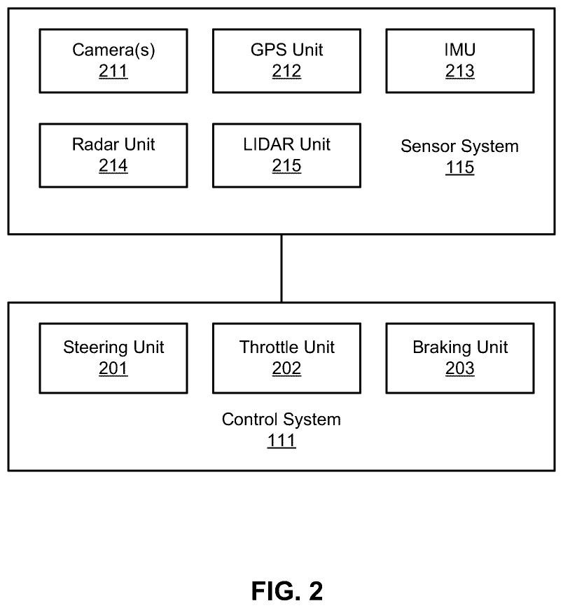

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

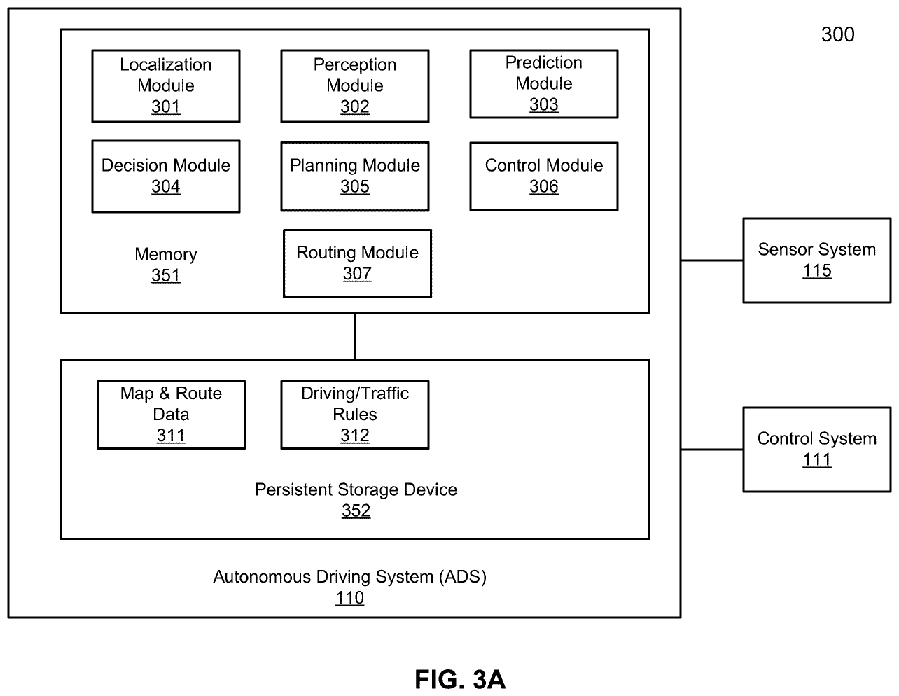

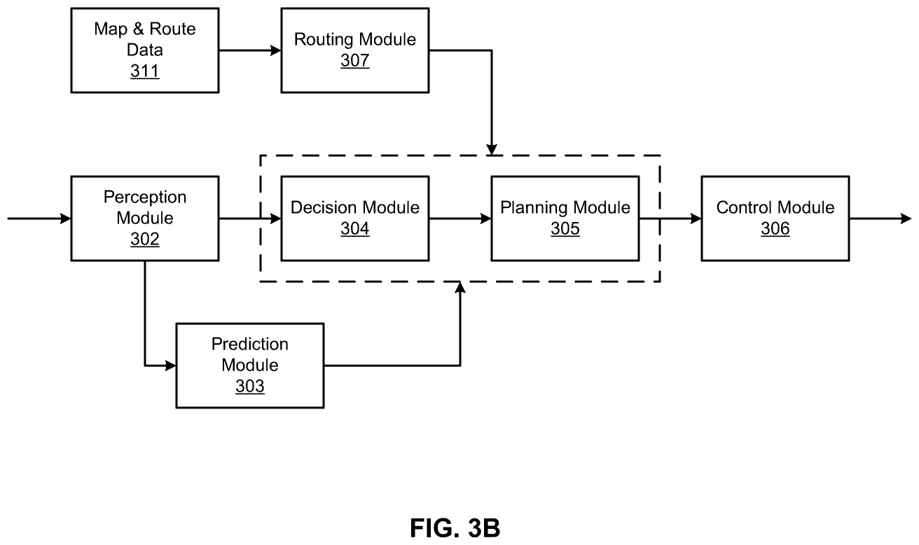

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

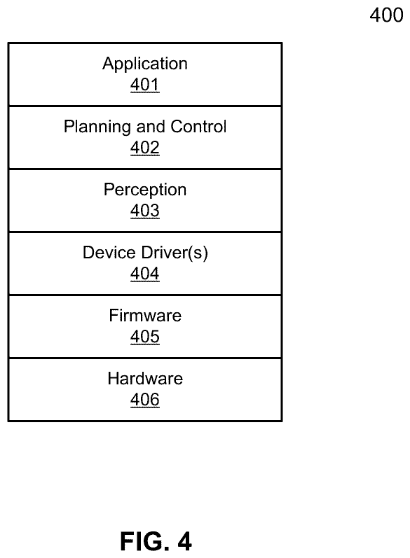

FIG. 4 is a block diagram illustrating system architecture for autonomous driving according to one embodiment. System architecture 400 may represent system architecture of an autonomous driving system as shown in FIGS. 3A and 3B. Referring to FIG. 4, system architecture 400 includes, but it is not limited to, application layer 401, planning and control (PNC) layer 402, perception layer 403, driver layer 404, firmware layer 405, and hardware layer 406. Application layer 401 may include user interface or configuration application that interacts with users or passengers of an autonomous driving vehicle, such as, for example, functionalities associated with user interface system 113. PNC layer 402 may include functionalities of at least planning module 305 and control module 306. Perception layer 403 may include functionalities of at least perception module 302. In one embodiment, there is an additional layer including the functionalities of prediction module 303 and/or decision module 304. Alternatively, such functionalities may be included in PNC layer 402 and/or perception layer 403. System architecture 400 further includes driver layer 404, firmware layer 405, and hardware layer 406. Firmware layer 405 may represent at least the functionality of sensor system 115, which may be implemented in a form of a field programmable gate array (FPGA). Hardware layer 406 may represent the hardware of the autonomous driving vehicle such as control system 111. Layers 401-403 can communicate with firmware layer 405 and hardware layer 406 via device driver layer 404.

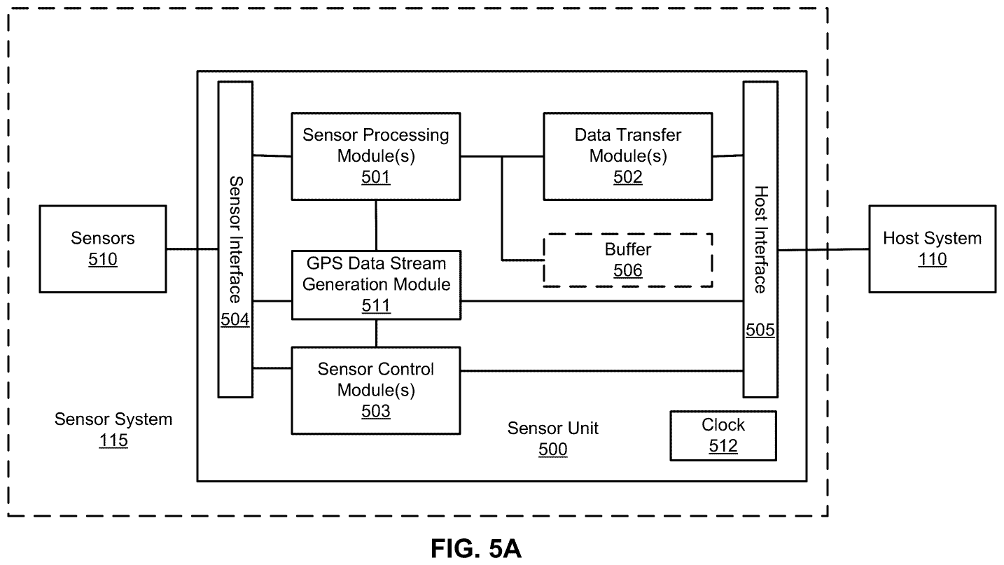

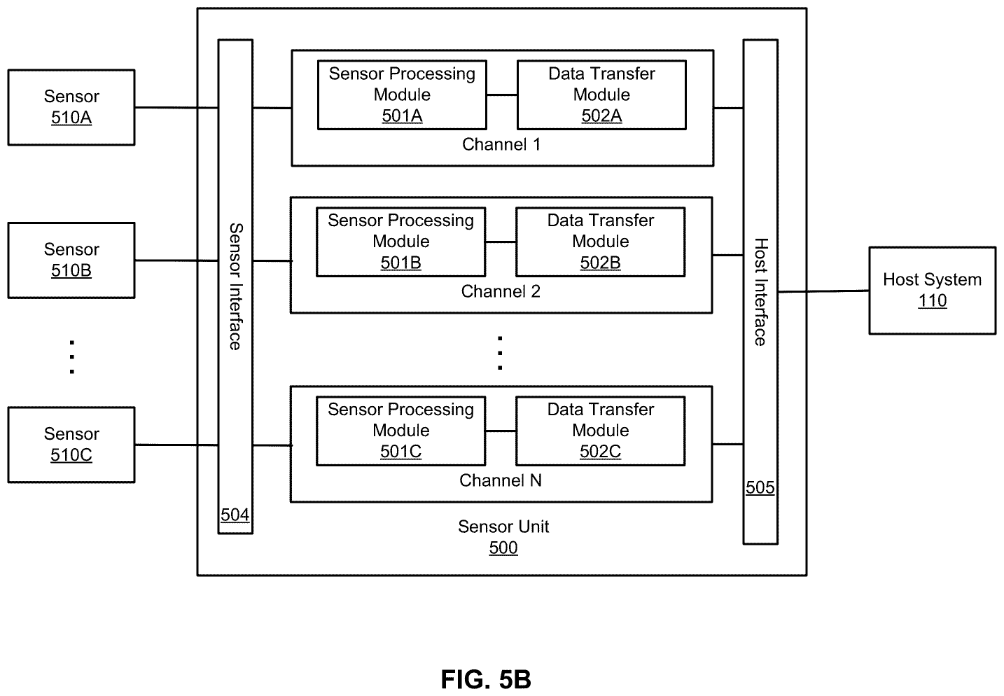

FIG. 5A is a block diagram illustrating an example of a sensor system according to one embodiment of the invention. Referring to FIG. 5A, sensor system 115 includes a number of sensors 510 and a sensor unit 500 coupled to host system 110. Host system 110 represents a planning and control system as described above, which may include at least some of the modules as shown in FIGS. 3A and 3B. Sensor unit 500 may be implemented in a form of an FPGA device or an ASIC (application specific integrated circuit) device. In one embodiment, sensor unit 500 includes, amongst others, one or more sensor data processing modules 501 (also simply referred to as sensor processing modules), data transfer modules 502, and sensor control modules or logic 503. Modules 501-503 can communicate with sensors 510 via a sensor interface 504 and communicate with host system 110 via host interface 505. Optionally, an internal or external buffer 506 may be utilized for buffering the data for processing.

In one embodiment, for the receiving path or upstream direction, sensor processing module 501 is configured to receive sensor data from a sensor via sensor interface 504 and process the sensor data (e.g., format conversion, error checking), which may be temporarily stored in buffer 506. Data transfer module 502 is configured to transfer the processed data to host system 110 using a communication protocol compatible with host interface 505. Similarly, for the transmitting path or downstream direction, data transfer module 502 is configured to receive data or commands from host system 110. The data is then processed by sensor processing module 501 to a format that is compatible with the corresponding sensor. The processed data is then transmitted to the sensor.

In one embodiment, sensor control module or logic 503 is configured to control certain operations of sensors 510, such as, for example, timing of activation of capturing sensor data, in response to commands received from host system (e.g., perception module 302) via host interface 505. Host system 110 can configure sensors 510 to capture sensor data in a collaborative and/or synchronized manner, such that the sensor data can be utilized to perceive a driving environment surrounding the vehicle at any point in time.

Sensor interface 504 can include one or more of Ethernet, USB (universal serial bus), LTE (long term evolution) or cellular, WiFi, GPS, camera, CAN, serial (e.g., universal asynchronous receiver transmitter or UART), SIM (subscriber identification module) card, and other general purpose input/output (GPIO) interfaces. Host interface 505 may be any high speed or high bandwidth interface such as PCIe (peripheral component interconnect or PCI express) interface. Sensors 510 can include a variety of sensors that are utilized in an autonomous driving vehicle, such as, for example, a camera, a LIDAR device, a RADAR device, a GPS receiver, an IMU, an ultrasonic sensor, a GNSS (global navigation satellite system) receiver, an LTE or cellular SIM card, vehicle sensors (e.g., throttle, brake, steering sensors), and system sensors (e.g., temperature, humidity, pressure sensors), etc.

For example, a camera can be coupled via an Ethernet or a GPIO interface. A GPS sensor can be coupled via a USB or a specific GPS interface. Vehicle sensors can be coupled via a CAN interface. A RADAR sensor or an ultrasonic sensor can be coupled via a GPIO interface. A LIDAR device can be coupled via an Ethernet interface. An external SIM module can be coupled via an LTE interface. Similarly, an internal SIM module can be inserted onto a SIM socket of sensor unit 500. The serial interface such as UART can be coupled with a console system for debug purposes.

Note that sensors 510 can be any kind of sensors and provided by various vendors or suppliers. Sensor processing module 501 is configured to handle different types of sensors and their respective data formats and communication protocols. According to one embodiment, each of sensors 510 is associated with a specific channel for processing sensor data and transferring the processed sensor data between host system 110 and the corresponding sensor. Each channel includes a specific sensor processing module and a specific data transfer module that have been configured or programmed to handle the corresponding sensor data and protocol, as shown in FIG. 5B.

Referring now to FIG. 5B, sensor processing modules 501A-501C are specifically configured to process sensor data obtained from sensors 510A-510C respectively. Note that sensors 510A-510C may the same or different types of sensors. Sensor processing modules 501A-501C can be configured (e.g., software configurable) to handle different sensor processes for different types of sensors. For example, if sensor 510A is a camera, processing module 501A can be figured to handle pixel processing operations on the specific pixel data representing an image captured by camera 510A. Similarly, if sensor 510A is a LIDAR device, processing module 501A is configured to process LIDAR data specifically. That is, according to one embodiment, dependent upon the specific type of a particular sensor, its corresponding processing module can be configured to process the corresponding sensor data using a specific process or method corresponding to the type of sensor data.

Similarly, data transfer modules 502A-502C can be configured to operate in different modes, as different kinds of sensor data may be in different size or sensitivities that require different speed or timing requirement. According to one embodiment, each of data transfer modules 502A-502C can be configured to operate in one of a low latency mode, a high bandwidth mode, and a memory mode (also referred to as a fixed memory mode).

When operating in a low latency mode, according to one embodiment, a data transfer module (e.g., data transfer module 502) is configured to send the sensor data received from a sensor to the host system as soon as possible without or with minimum delay. Some of sensor data are very sensitive in terms of timing that need to be processed as soon as possible. Examples of such sensor data include vehicle status such as vehicle speed, acceleration, steering angle, etc.

When operating in a high bandwidth mode, according to one embodiment, a data transfer module (e.g., data transfer module 502) is configured to accumulate the sensor data received from a sensor up to a predetermined amount, but is still within the bandwidth the connection between the data transfer module and the host system 110. The accumulated sensor data is then transferred to the host system 110 in a batch that maximum the bandwidth of the connection between the data transfer module and host system 110. Typically, the high bandwidth mode is utilized for a sensor that produces a large amount of sensor data. Examples of such sensor data include camera pixel data.

When operating in a memory mode, according to one embodiment, a data transfer module is configured to write the sensor data received from a sensor directly to a memory location of a mapped memory of host system 110, similar to a shared memory page. Examples of the sensor data to be transferred using memory mode include system status data such as temperature, fans speed, etc.

Referring to FIG. 5A, in one embodiment, sensor unit 500 includes GPS data stream generation module 511. Module 511 can receive two or more GPS synchronization signals from a GPS unit/receiver and combine the signals into a single signal stream. The single synchronization signal stream can be communicated to one or more sensors 510 via sensor interface 504. For example, the synchronization signal can be communicated to a camera sensor 510 (or other sensors, such as LIDAR, RADAR, etc.) to trigger the image captures at specified times intervals.

In one embodiment, the single synchronization signal stream can be communicated to subsystems, at host system 110, via host interface 505. The subsystems can include control system 111, communication system 112 user interface system 113, and autonomous driving system (ADS) 110, or the like, as shown in FIG. 1. In one embodiment, the synchronization signal can be sent to different modules of ADS 110, such as localization module 301, perception module 302, prediction module 303, decision/planning modules 304/305, control module 306, routing module 307, or the like, as shown in FIG. 3A.

Referring to FIG. 5A, in one embodiment, the single synchronization signal stream can be used by sensor processing module 501 to append a high precision time signature to sensor data for any of sensors 510. The high precision time signature can include a detailed timestamp using any of the information from the NMEA-formatted message and can align (or synchronize) the sensor data to timing information from the PPS signal, e.g., with an accuracy in the orders of a few nanoseconds. Synchronization can be implemented by hardware or software, or a combination thereof.

In one embodiment, clock 512 can sync to the timing information of the PPS signal and clock 512 provides a common clock to various subsystems or modules of ADV 101. For example, sensor data can thereafter sync to clock 512. In one embodiment, sensor data syncs directly to the timing information of the PPS signal using a phase locked-loop (PLL), or some timer/counter mechanisms implemented by clock 512 of sensor unit 500.

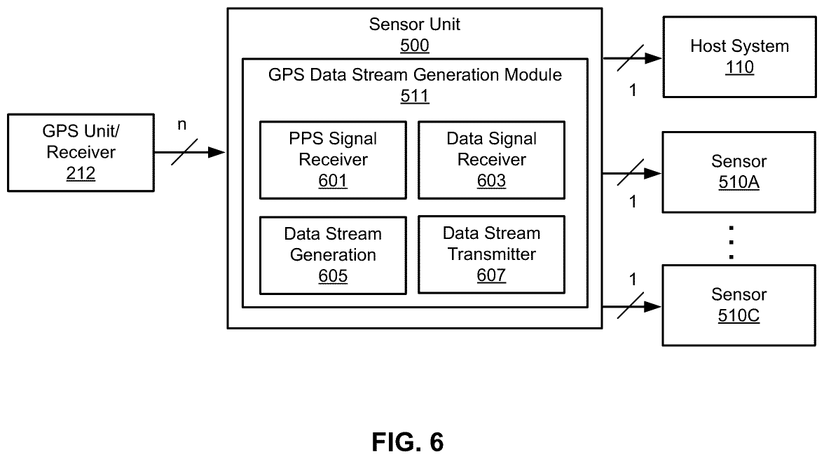

FIG. 6 is a block diagram illustrating an example of a GPS data stream generation module 511 according to one embodiment. GPS data stream generation module 511 can receive one or more (denoted n) synchronization signals from GPS unit/receiver 212 and combine the signals into a single data stream. In one embodiment, GPS data stream generation module 511 includes PPS signal receiver 601, data signal receiver 603, data stream generation 605, and data stream transmitter 607. PPS signal receiver 601 can receive a pulse-per-second (PPS) signal from a GPS receiver 212. The PPS signal can have a sharp rising edge, at approximately 10 ns. Data signal receiver 603 can receive a data signal from GPS receiver 212. The data signal can include a NMEA-formatted message, such as a GPRMC or GPZDA message. Data stream generation 605 can generate a data stream using the PPS signal and the data signal. Data stream transmitter 607 can transmit the generated data stream to one or more subsystems at host system 110 and/or sensors 510A-510C of ADV using single interconnects. All or some of modules 601-607 can be integrated as one or more modules.

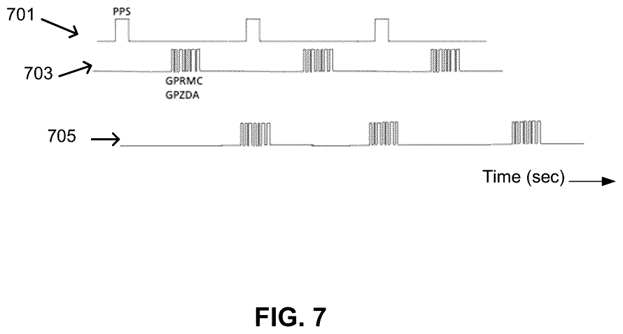

FIG. 7 illustrates a time diagram of GPS data stream generation according to one embodiment. Referring to FIG. 7, signal 701 can represent a synchronization signal for a pulse-per-second signal. The pulse-per-second (PPS) signal can be provided by GPS unit 212 over a GPIO pin or any other GPS-specific interfaces (e.g., interface 504). The PPS signal is an accurate timing signal that can sync the time clock of various subsystems, sensor modules, and/or devices of ADV 101 to a common clock (e.g., clock 512 of FIG. 5A). Signal 703 can be a NMEA data stream provided by GPS unit 212 over a UART/GPIO/RS232 pin or any other GPS-specific interfaces (e.g., interface 504). The NMEA data stream can include the PVT (position, velocity, time) information computed by GPS unit 212. In one embodiment, signal 703 can be formatted as GPRMC, GPZDA, or other formats. An example of a GPRMC message can be:

$GPRMC,123519,A,4807.038,N,01131.000,E,022.4,084.4,230394,003.1,W*43, where RMC denotes recommended minimum sentence C; 123519 denotes 12:35:19 UTC; A denotes status (A=active or V=Void); 4807.038,N denotes Latitude 48 deg 07.038′ N; 01131.000,E denotes Longitude 11 deg 31.000′ E; 022.4 denotes speed over the ground in knots; 084.4 denotes track angle in degrees; 230394 denotes the date being 23 Mar. 1994, 003.1,W denotes magnetic variation; and *43 denotes the checksum data beginning with *.

The PPS signal 701 is a narrow signal pulses which repeats once per second, but signal 701 could also repeat faster, e.g., approximately 10 hertz. The detailed timing information is included in GPRMC message 703 using time format such as UTC, hhmmss.ssxxxx, where the actual precision depends on the GPS unit/receiver 212 and the GPS service provider (e.g., GPS, or GLONASS, BeiDou, etc.). GPRMC messages 703 are received at about a same or half the intervals of the PPS pulses and the message length can be defined by the vendor of the GPS receiver. The date and timing information could be several hundred bits in ASCII format.

Conventionally, the GPRMC message and/or the PPS signal can be transmitted using the general purpose input/output (GPIO) protocol, where one pin is used for PPS (approximately 10 ns rising edge at approximately 100 MHz) signal 701, and another pin is used for GPRMC signal 703.

In one embodiment, signals 701 and 703 are combined and the combined data stream signal 705 is communicated uses one interconnect/pin (10 ns rising edge at approximately 100 MHz).

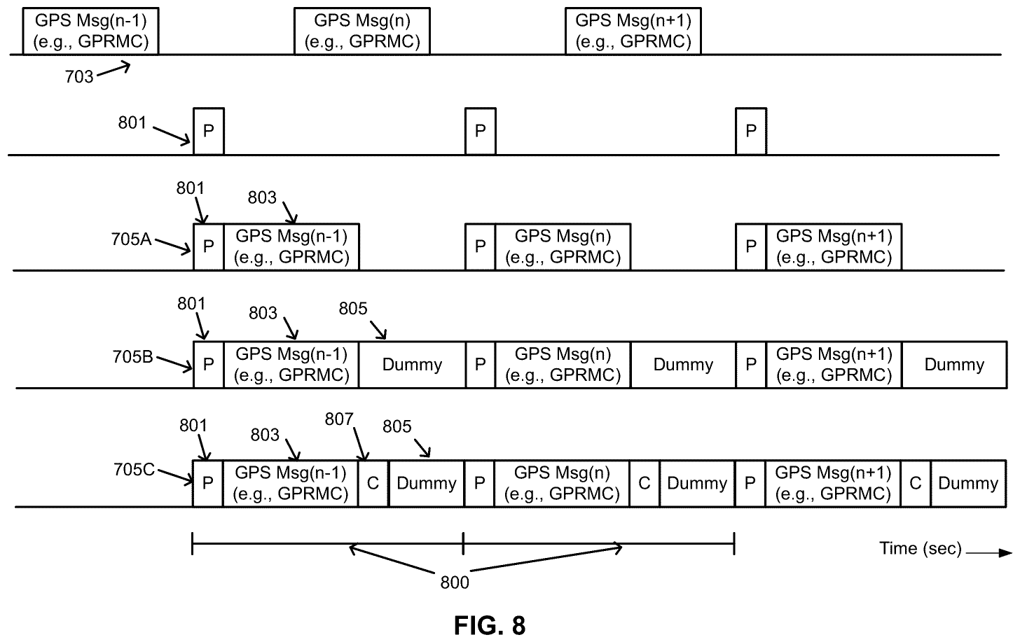

FIG. 8 illustrates examples of GPS synchronization data streams according to one embodiment. Referring to FIGS. 7-8, input synchronization signals 701 and 703 are provided by GPS unit 212 and a GPS data stream generation module, such as module 511 of FIG. 6, uses the input synchronization signals 701 and 703 to generate output data stream 705.

Referring to FIG. 8, data stream 705 includes at least a P segment 801 and GPRMC data stream 803. Data streams 705A-C can represent variations of data stream 705. In one embodiment, pulse (P) segment 801 can represent a coded header with the first bit of the P segment corresponding to a rising edge of the PPS signal 701. In one embodiment, each of frames 800 can include a P coded header. The coded header P can be a unique sequence of bits that repeats at every frame (e.g., every second), such as a coded reference signal. The P segment can be used for synchronization or reference purposes.

In one embodiment, GPRMC signal 703 is stored in buffer, then a GPRMC message of the GPRMC signal 703 is replayed as soon as a PPS pulse of signal 701 is received (e.g., GPRMC signal 703 is delayed and concatenated to the end of P data segment 801). In one embodiment, data stream 705A includes P segment 801 and GPRMC data segment 803, where GPRMC data segment 803 has the original GPRMC message 703.

In one embodiment, data stream 705B includes dummy bits 805 (e.g., zero values) that are appended after GPRMC data segment 803 as fillers. In one embodiment, data stream 705C further includes the C segment 807, where C represent error correction codes for frame 803 for data integrity. The C segment can be a cyclic redundancy check (CRC), forward error check (FEC) codes, or the like. C segment 807 can be appended after GPRMC data segment 803 and dummy 805 is appended after C segment 807.

To keep the precision of 10 ns, data stream 705 can be transmitted on a transmission line with a bit rate equal to or greater than 100 MHz. In one embodiment, data stream 705 is transmitted using the GPIO interface set to a high speed frequency of 100 MHz. The data stream 705 can be transmitted to other subsystems and/or sensor modules, using a single transmission line. In one embodiment, data stream 705 is transmitted using the PCI-E interface. In one embodiment, data stream 705 is buffered prior to transmission to other subsystems and/or sensor modules. Although GPIO/PCI-E interfaces are illustrated above, data stream 705 can be transmitted using other types of interfaces.

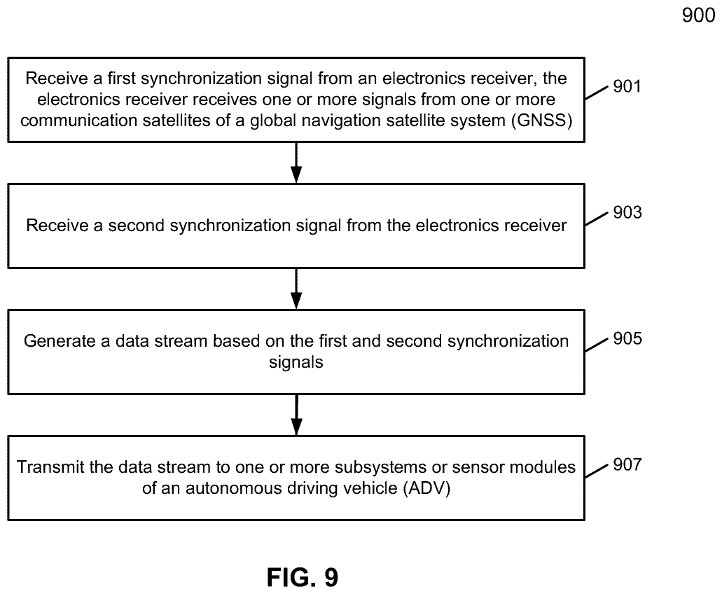

FIG. 9 is a flow diagram of a method to generate a GPS data stream according to one embodiment. Process 900 may be performed by processing logic which may include software, hardware, or a combination thereof. For example, process 900 may be performed by module 511 of FIG. 6.

At block 901, processing logic receives a first synchronization signal (e.g., PPS signal) from an electronics receiver (e.g., GPS unit/receiver 212), where the electronics receiver receives one or more signals from one or more communication satellites of a navigation satellite system.

At block 903, processing logic receives a second synchronization signal (NMEA data) from the electronics receiver (e.g., GPS unit/receiver 212).

At block 905, processing logic generates a data stream based on the first and second synchronization signals.

At block 907, processing logic transmits the data stream to one or more subsystems or sensor modules of an autonomous driving vehicle (ADV), where the data stream is used for localization and time synchronization for the one or more subsystems or sensor modules.

In one embodiment, the first synchronization signal is a pulse-per-second (PPS) signal correspond to a radio pulse from a communication satellite of the navigation satellite system indicating a presence of the communication satellite.

In one embodiment, the second synchronization signal includes a national marine electronics association (NMEA)-formatted message and the NMEA-formatted message is a GPRMC or a GPZDA message received from the one or more communication satellites.

In one embodiment, the GPRMC or the GPZDA message includes localization information of the one or more communication satellites.

In one embodiment, processing logic further transmits the data stream to one of the one or more subsystems or sensor modules of the ADV by a single transmission line using a single pin.

In one embodiment, the data stream includes one or more data frames and each of the one or more data frames include: a first data segment representing a frame header signal corresponding to the first synchronization signal; and a second data segment representing the second synchronization signal.

In one embodiment, the data frame further includes: a third data segment representing an error correction code, including a forward error correction code or a cyclic redundancy check code; and a fourth data segment representing a dummy data.

In one embodiment, the second data segment is a replay of a GPRMC or a GPZDA message buffered at a time prior to receipt of the first synchronization signal for the data frame.

In one embodiment, processing logic codes the frame header signal as a unique sequence of bits as an identifier of the first synchronization signal, where the frame header signal is a same signal for the one or more data frames.

In one embodiment, the navigation satellite system includes a global positioning system (GPS) or a BeiDou navigation satellite system.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
receiving a first synchronization signal from an electronics receiver, the electronics receiver receives one or more signals from one or more communication satellites of a navigation satellite system;
receiving a second synchronization signal from the electronics receiver;
generating a data stream based on the first and second synchronization signals; and
transmitting the data stream to one or more subsystems or sensor modules of an autonomous driving vehicle (ADV), wherein the data stream is used for localization and time synchronization for the one or more subsystems or sensor modules.

2. The method of claim 1, wherein the first synchronization signal is a pulse-per-second (PPS) signal correspond to a radio pulse from a communication satellite of the navigation satellite system indicating a presence of the communication satellite.

3. The method of claim 1, wherein the second synchronization signal includes a national marine electronics association (NMEA)-formatted message and the NMEA-formatted message is a GPRMC or a GPZDA message received from the one or more communication satellites.

4. The method of claim 1, wherein the GPRMC or the GPZDA message includes localization information of the one or more communication satellites.

5. The method of claim 1, further comprising: transmitting the data stream to one of the one or more subsystems or sensor modules of the ADV by a single transmission line using a single pin.

6. The method of claim 1, wherein the data stream comprises one or more data frames and each of the one or more data frames comprises:
a first data segment representing a frame header signal corresponding to the first synchronization signal; and
a second data segment representing the second synchronization signal.

7. The method of claim 6, wherein the data frame further comprises:
a third data segment representing an error correction code, including a forward error correction code or a cyclic redundancy check code; and
a fourth data segment representing a dummy data.

8. The method of claim 6, wherein the second data segment is a replay of a GPRMC or a GPZDA message buffered at a time prior to receipt of the first synchronization signal for the data frame.

9. The method of claim 6, further comprising: coding the frame header signal as a unique sequence of bits as an identifier of the first synchronization signal, wherein the frame header signal is a same signal for the one or more data frames.

10. The method of claim 1, wherein the navigation satellite system includes a global positioning system (GPS) or a BeiDou navigation satellite system.

11. A non-transitory machine-readable medium having instructions stored therein, which when executed by a processor, cause the processor to perform operations, the operations comprising:
receiving a first synchronization signal from an electronics receiver, the electronics receiver receives one or more signals from one or more communication satellites of a navigation satellite system;
receiving a second synchronization signal from the electronics receiver;
generating a data stream based on the first and second synchronization signals; and
transmitting the data stream to one or more subsystems or sensor modules of an autonomous driving vehicle (ADV), wherein the data stream is used for localization and time synchronization for the one or more subsystems or sensor modules.

12. The non-transitory machine-readable medium of claim 11, wherein the first synchronization signal is a pulse-per-second (PPS) signal correspond to a radio pulse from a communication satellite of the navigation satellite system indicating a presence of the communication satellite.

13. The non-transitory machine-readable medium of claim 11, wherein the second synchronization signal includes a national marine electronics association (NMEA)-formatted message and the NMEA-formatted message is a GPRMC or a GPZDA message received from the one or more communication satellites.

14. The non-transitory machine-readable medium of claim 11, wherein the GPRMC or the GPZDA message includes localization information of the one or more communication satellites.

15. The non-transitory machine-readable medium of claim 11, wherein the operations further comprise: transmitting the data stream to one of the one or more subsystems or sensor modules of the ADV by a single transmission line using a single pin.

16. A data processing system, comprising:
a processor; and
a memory coupled to the processor to store instructions, which when executed by the processor, cause the processor to perform operations, the operations including
receiving a first synchronization signal from an electronics receiver, the electronics receiver receives one or more signals from one or more communication satellites of a navigation satellite system;
receiving a second synchronization signal from the electronics receiver;
generating a data stream based on the first and second synchronization signals; and
transmitting the data stream to one or more subsystems or sensor modules of an autonomous driving vehicle (ADV), wherein the data stream is used for localization and time synchronization for the one or more subsystems or sensor modules.

17. The system of claim 16, wherein the first synchronization signal is a pulse-per-second (PPS) signal correspond to a radio pulse from a communication satellite of the navigation satellite system indicating a presence of the communication satellite.

18. The system of claim 16, wherein the second synchronization signal includes a national marine electronics association (NMEA)-formatted message and the NMEA-formatted message is a GPRMC or a GPZDA message received from the one or more communication satellites.

19. The system of claim 16, wherein the GPRMC or the GPZDA message includes localization information of the one or more communication satellites.

20. The system of claim 16, wherein the operations further comprise: transmitting the data stream to one of the one or more subsystems or sensor modules of the ADV by a single transmission line using a single pin.
